(19) United States
(12) Patent Application Publication
(10) Pub. No.: US 2016/0338494 A1
(43) Pub. Date: Nov. 24, 2016

(54) Seatback Utility Device and Concession Holder

(71) Applicants: Gregory J. Beinecke, Scottsdale, AZ (US); Nolan Kucich, Old Brookville, NY (US)

(72) Inventors: Gregory J. Beinecke, Scottsdale, AZ (US); Nolan Kucich, Old Brookville, NY (US)

(21) Appl. No.: 15/161,169

(22) Filed: May 20, 2016

Related U.S. Application Data
(60) Provisional application No. 62/164,449, filed on May 20, 2015.

(51) Int. Cl. A47C 7/62; A45C 13/00; B65D 25/22; A45F 5/00; F16M 13/02

(52) U.S. Cl. CPC A47C 7/62; A45F 5/00; F16M 13/02; B65D 25/22; A45C 13/001

(57) ABSTRACT

A seatback utility device provides a compact and convenient way to address the need to hold personal articles and concession snacks. An arched protrusion from the seatback extends most of the way across the seatback, and is configured to hold a variety of items brought to a sporting event by a patron. One embodiment may securely retain an appropriately configured concession tray or box. In some embodiments, electronic or fixed, movable advertising displays may be accommodated.

### CROSS REFERENCE TO RELATED APPLICATIONS

This application claims the benefit of provisional patent application No. 62/164,449, filed May 20, 2015.

### BACKGROUND OF THE INVENTION

In theaters and sports stadiums rows of seats are fixed in place so that spectators seated therein may observe the performance or sports event. Stadium seats typically are arranged in an inclined or stepped-up stadium tier configuration in multiple rows of seats, each comprising a seating portion and a backrest portion, supported laterally on either side by a seat standard having an armrest portion that may be shared between spectators. In between the rows or tiers are relatively narrow aisles that permit access to and from interiorly disposed stadium seats. Refreshments or concessions sold by stadiums, theaters and arenas are often enjoyed by the spectators including food and drink of various types. Once purchased, however, a patron must take care to avoid spills or other mishaps that may occur as a result of the patron having to manually support or balance the concessions, or having to place the concessions in the aisle area near the patron's feet. Similarly, patrons with purses and small objects such as cell phones face the choice of holding them in the lap or placing them at the feet. It would be advantageous to have a device attached to the seatback in front of a patron that holds items carried by the patron while not unduly blocking the aisle behind that seatback.

### BRIEF SUMMARY OF THE INVENTION

The present invention provides a compact and convenient way to address the need to hold personal articles and concession snacks. An arched protrusion from the seatback extends most of the way across the seatback, and is configured to hold a variety of items brought to a sporting event by a patron. One embodiment may securely retain an appropriately configured concession tray or box. In some embodiments, electronic or fixed, movable advertising displays may be accommodated.

### BRIEF DESCRIPTION OF THE DRAWINGS

FIG. 1 is a depiction of an embodiment of the invention in place on a section of typical stadium seat backs.

FIG. 2 is front view of an embodiment of the device.

FIG. 3 is a back view of the embodiment of FIG. 2.

FIG. 4 is a top view of the embodiment of FIG. 2.

FIG. 5 is a side view of the embodiment of FIG. 2.

FIG. 6 is a close up of a portion of an embodiment showing a center post.

FIG. 7 shows an embodiment of the invention holding a short strap purse.

FIG. 8 shows an embodiment of the invention holding a long strap purse.

FIG. 9 shows an embodiment of the invention holding a tablet.

FIG. 10 shows a version of a snack tray that may be used with some embodiments of the invention.

FIG. 11 shows the snack tray of FIG. 10 engaged with the device.

FIG. 12 shows an embodiment comprising a single post attached to the seat back.

FIG. 13 shows the snack tray of FIG. 10 engaged with the post of FIG. 12

FIG. 14 shows a front view of a different embodiment of the device.

FIG. 15 shows a side view of the embodiment of FIG. 14

### DETAILED DESCRIPTION

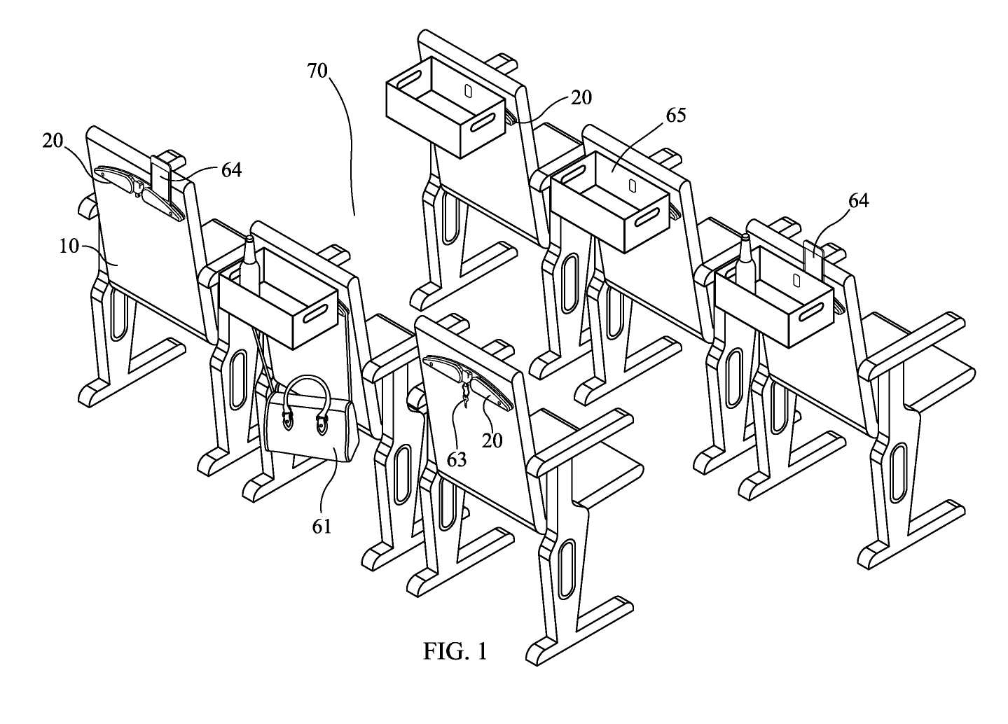

As seen in FIG. 1, one embodiment of the device is a structure 20 for mounting to the upper outside back of a seat 10, for use by the patron sitting in the row behind. The device provides a compact way to store a patron's articles during the event, keeping them handy, in sight, and minimizing obstruction of the passageway 70 between rows of seats. Several examples of patron articles are illustrated, including a long strap purse 61, a set of keys 63, a cell phone 64 and a snack tray 65.

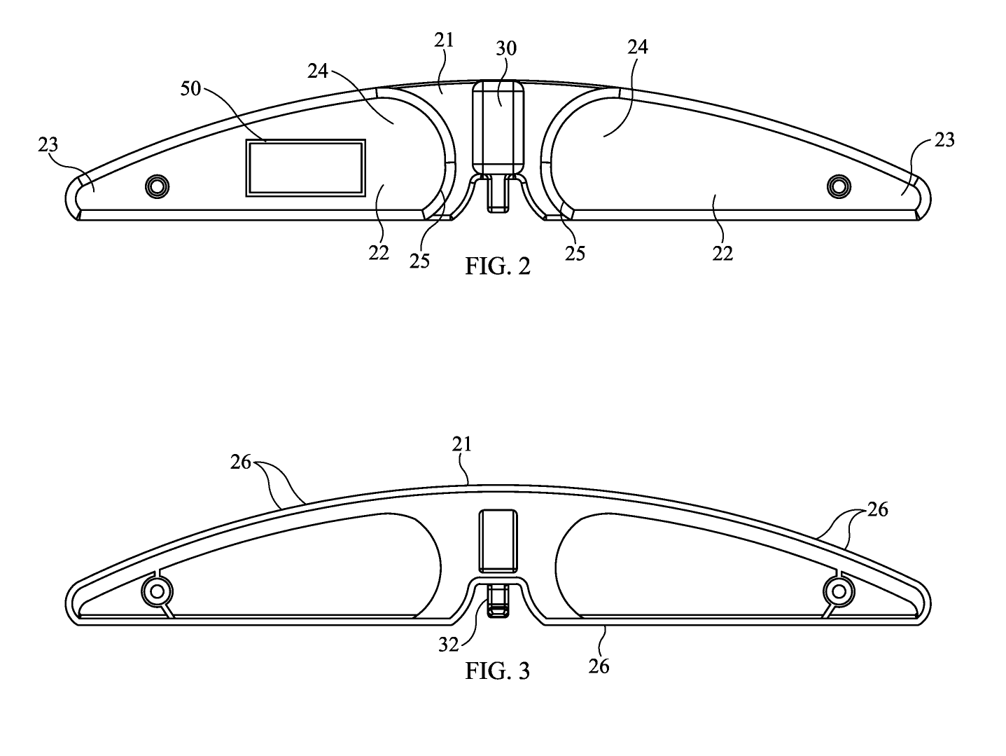

An embodiment of the seatback holder is shown in more detail in FIGS. 2-4. The back wall 21 comprises a shallow arch, having a length about the same as the width of the seat back 10. The front wall comprises a pair of curved elements 22 that match or conform to the shape of the back wall at the extremities 23 then sharply curve inward near the center 24. A holding post 30, described below, is located between the inner curved surfaces 25 of the curved elements 24.

In one embodiment, the back wall 21 is a peripheral frame 26. The wall may also be a solid sheet or a cut-out structure. The back wall 21 and the front wall 22 are connected by a plurality of upper connectors 40 and lower connectors 46. In an embodiment, the connectors 40 create a space 41 between the front wall 22 and back wall 21 that is wide enough to accommodate a purse strap and is also slightly wider than a cell phone. At the top of the device, connectors 40 are positioned slightly below the top edge 43 of the front wall and the top edge 44 of the back wall, forming a slot 45 that can retain, for example, a purse strap. The connectors may be positioned to form an open-topped pocket 47 for retaining small articles such as cell phones. Optionally, a rectangular aperture 50 with an enclosure may be added to the front wall on either side, to hold a low power display, such as an LED screen, or a physical insert, such as a card or block, to use to display advertising or messages.

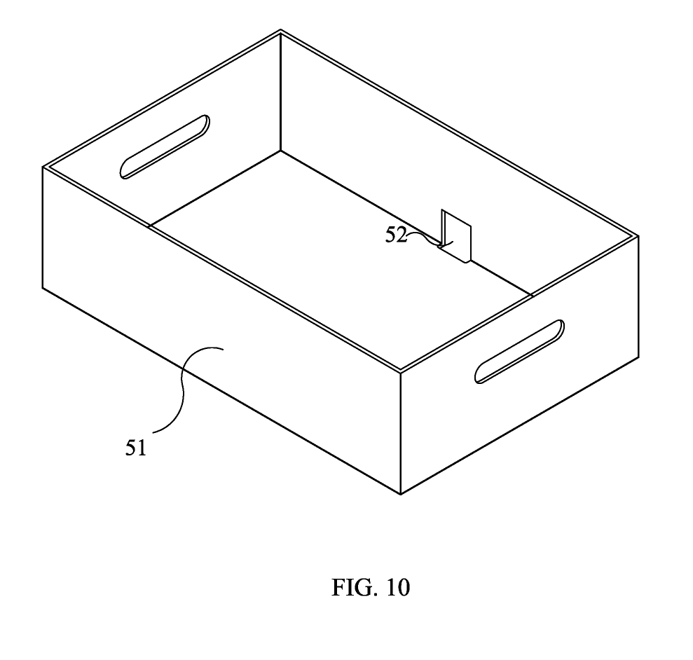

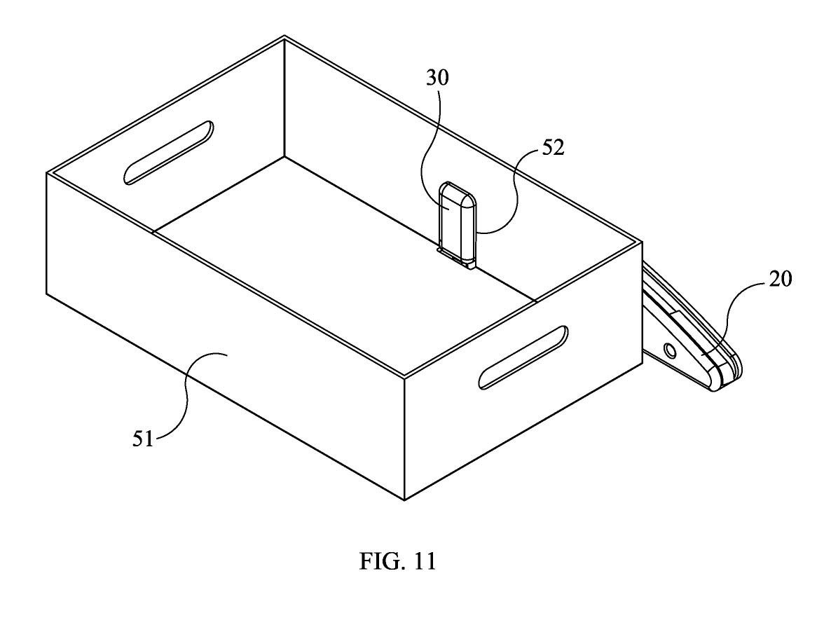

As illustrated in FIG. 6, in one embodiment the center post 30 extends slightly forward of the outer surface of the front wall 22, and includes a narrow slit 31 that is in alignment with said outer surface. The slit extends partway down the post, and in one embodiment extends about an inch. Extending below the center post there may be a hook structure 32 which may be used to hang a patron's keys. The front surface of the hook structure is aligned with the front of the slit and the outer surface of the front wall. The center post may engage with a removable snack tray to retain the tray in a convenient location. As illustrated in FIGS. 10-11, a tray/container 51 with an appropriately located aperture 52 may be placed over the post 30. The walls of the container are approximately the same width as the slit 31, allowing the post to grip the container above the aperture. The back surface of the container will press against the outer surface of front wall 22 and against the front surface of hook structure 32, providing rotational stability. Other items may be supported by the post as well. For example, a cup holder sleeve with an aperture similar to that shown on the snack tray may be used. Also, the post may be used to hold paper, cardboard or other advertising/promotional materials configured to fit thereon.

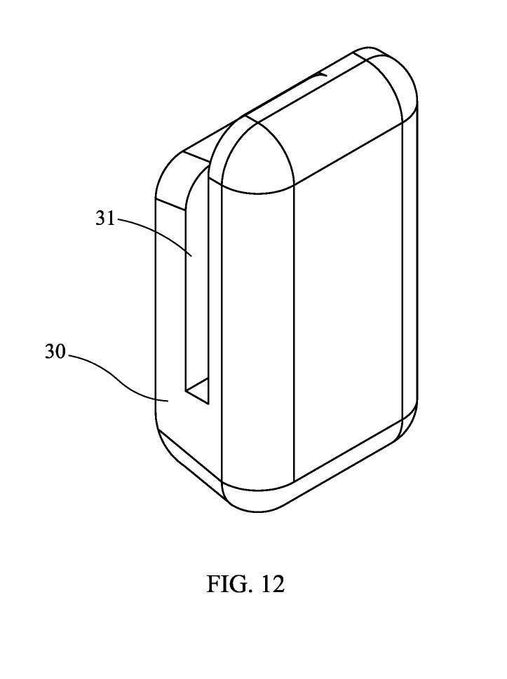

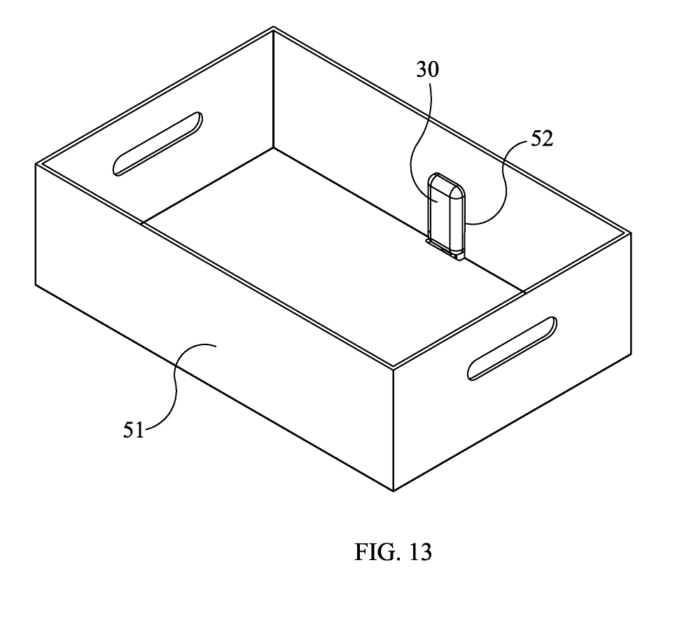

In another embodiment, a post 30 as described above may be positioned alone in the upper center of the seat back facing the patron behind the seat. See FIG. 12. The post may engage a snack tray in the manner described above See FIG. 13.

The typical stadium seat back is 17 to 22 inches across, with an average of 20 inches. Some are slightly curved. In a preferred embodiment, the articles holder has a length substantially the same as the seat back, leaving space at either end. The holder may be curved to conform to the shape of the seat back. The holder may be attached to the seat back by screws, glue, or another appropriate fixation. In some embodiments, the holder may be formed as a unitary structure with the seat back when it is manufactured.

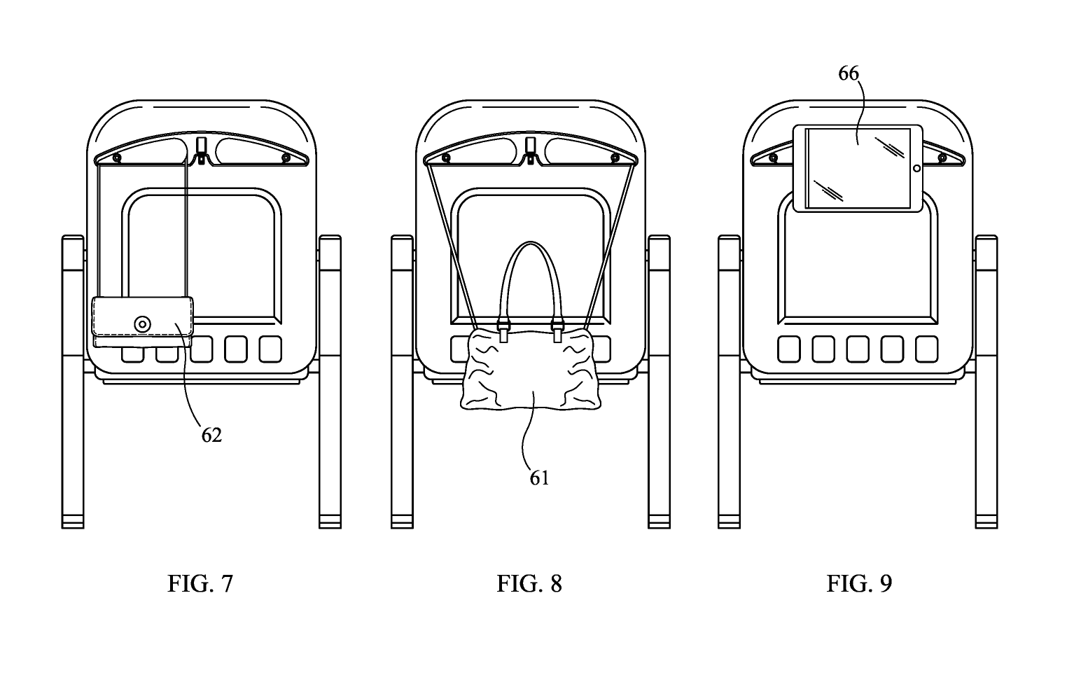

The articles holder is useful to hold a purse belonging to a patron sitting behind it. Purses known as “cross body” purses have straps in the 44 to 54 inch range. Such a long hang purse 61 may be draped across the entire holder, as shown in FIG. 8. With a length on the order of 17 inches, the articles holder readily suspends the purse above the floor. Purses with shorter straps 62 may be draped across one of the shorter front curved elements, as seen in FIG. 7. A one inch space between the front and back walls, forming a one inch wide slot, is adequate for most purses. Other items with straps or thin handles, such as merchandise bags, binoculars, cameras, or strapped containers, may be hung on the device as well. Optionally, a clip to secure the patron's tablet or other electronic device 66 may be included.

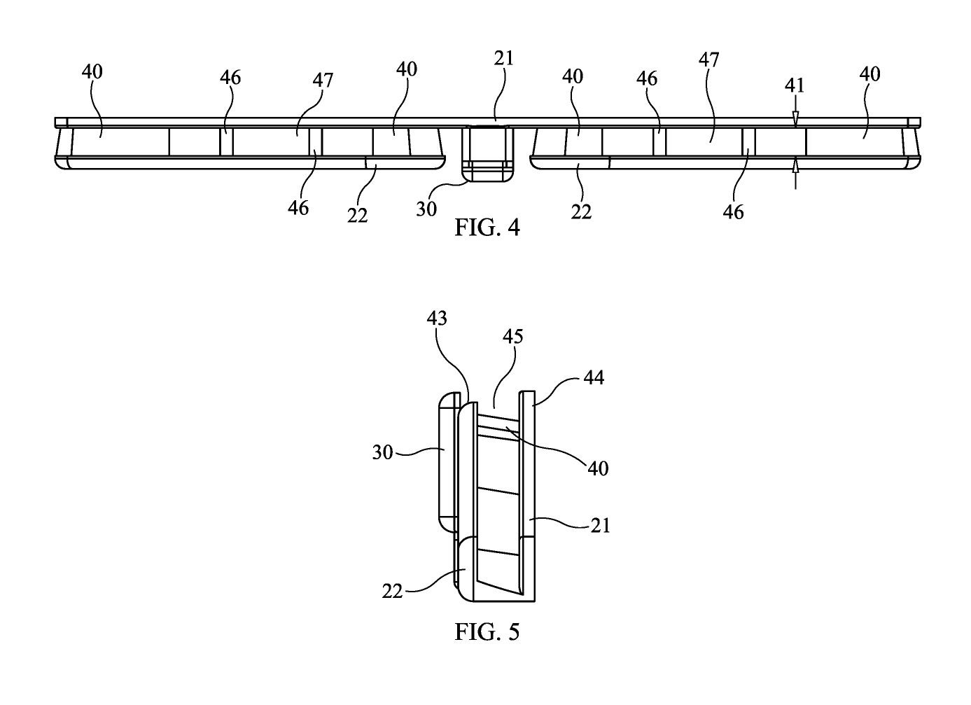

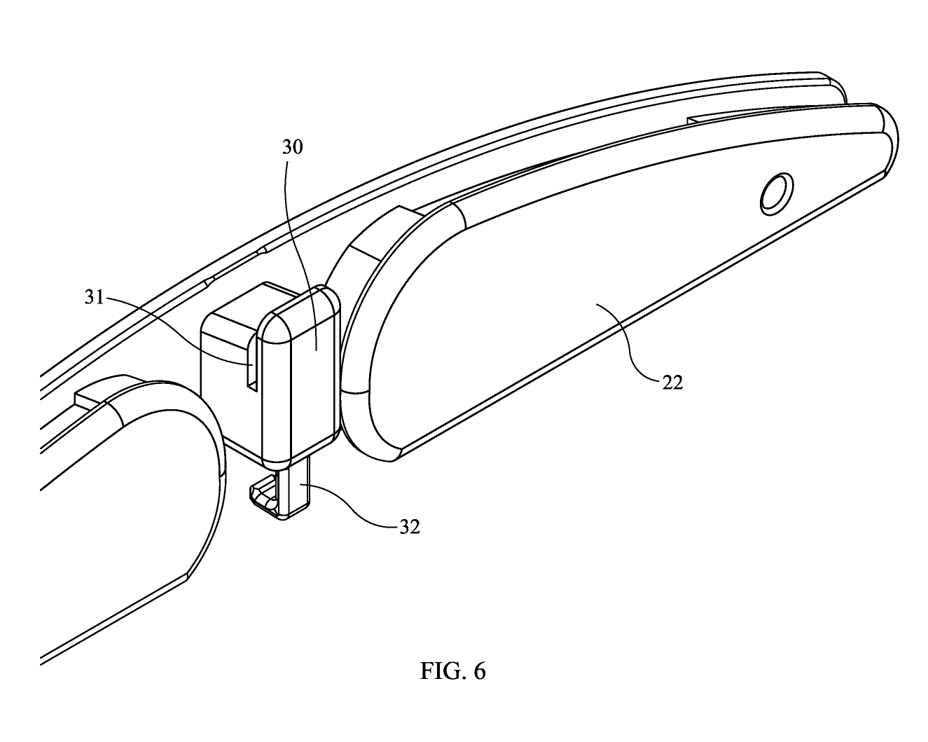

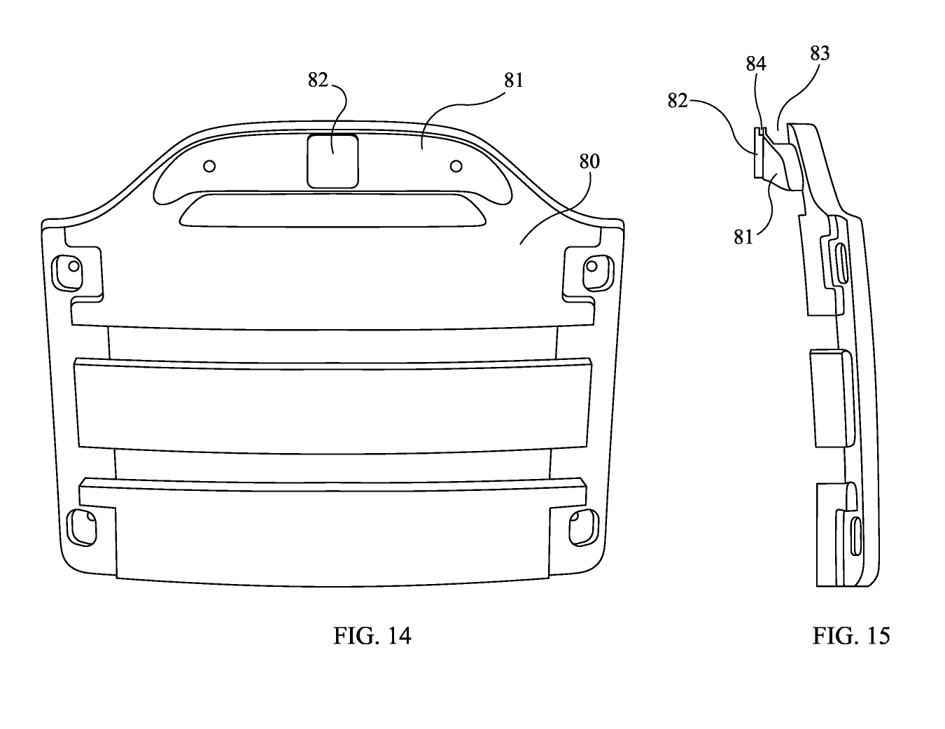

Another alternative embodiment is shown in FIGS. 14-15. The supporting seat back 80 has a variable curved top, and the device structure 81 conforms to that shape. Front and back walls of the device are like those in FIGS. 2-5 and there is a space therebetween like the space 41 in FIG. 4 and a slot 83 like the slot 45 in FIG. 5. Post 82, with a slit 84, extends outward like post 30 in FIGS. 5 and 6. This embodiment does not have the curved center portions 24 of the front wall that are shown in FIG. 2.

The foregoing description has been presented and is intended for the purposes of illustration and description. It is not intended to be exhaustive nor limit the invention to the above teachings. The embodiments were chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

What is claimed is:

1. A seat back mounted holder device comprising
a back wall attached to the seat back, wherein the back wall is substantially as long as the width of the seat back, having a relatively straight bottom side and a shallow convex curved top side;
a front wall positioned forward of the back wall, having a top and bottom parallel to the back wall top and bottom, and attached to and spaced apart from the back wall by connectors;
the walls and connectors defining a slot below the top of the walls running the length of the device;
and a central rectangular post extending outward beyond the front wall and having a narrow slit in alignment with the front wall.

2. The device of claim 1 further comprising a hook attached to and extending below the central rectangular post.

3. The device of claim 1 further comprising at least one open topped pocket defined by the front and back walls and one or more connectors.

4. The device of claim 2 further comprising at least one open topped pocket defined by the front and back walls and one or more connectors.

5. The device of claim 1 further comprising a rectangular container box having an opening in a back wall corresponding in dimension to the central post such that the box may be placed over the post with the box back wall inserted in the slit.

6. The device of claim 5 further comprising a hook attached to and extending below the central rectangular post.

7. The device of claim 1 wherein the front wall is configured in two segments, each segment comprising a shallow curve parallel to the back wall beginning at an outer extremity of the back wall, transitioning to a sharp return curve near the central post.

8. The device of claim 7 further comprising a hook attached to and extending below the central rectangular post.

9. The device of claim 7 further comprising at least one open topped pocket defined by the front and back walls and one or more connectors.

10. The device of claim 8 further comprising at least one open topped pocket defined by the front and back walls and one or more connectors.

11. The device of claim 7 further comprising a rectangular container box having an opening in a back wall corresponding in dimension to the central post such that the box may be placed over the post with the box back wall inserted in the slit.

12. The device of claim 9 further comprising a rectangular container box having an opening in a back wall corresponding in dimension to the central post such that the box may be placed over the post with the box back wall inserted in the slit.

13. A seat back mounted holder device, comprising a generally rectangular post having a top and bottom surface and front wall and back wall, the front wall extending slightly higher than the back wall, and incorporating a narrow slit from the top surface to a length about three quarters of the distance between the top and bottom.

14. The device of claim 13 further comprising a rectangular container box having an opening in a back wall corresponding in dimension to the post such that the box may be placed over the post with the box back wall inserted in the slit.
